(19) United States
(12) Patent Application Publication
(10) Pub. No.: US 2004/0060785 A1
(43) Pub. Date: Apr. 1, 2004

(54) Parking brake

(76) Inventors: Markus Bohm, Remscheid (DE); Ulf Braker, Berlin (DE); Michael Lorenz, Scharding (AT)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/432,497

(22) PCT Filed: Nov. 20, 2001
(86) PCT No.: PCT/DE01/04326

(30) Foreign Application Priority Data
Nov. 21, 2000 (DE) 100 57 909.4
May 15, 2001 (DE) 101 23 525.9

(51) Int. Cl. F16D 69/00

(52) U.S. Cl. 188/265; 74/503

(57) ABSTRACT

The invention relates to a parking brake for a vehicle, comprising a handle (2) which is a displaceably mounted with respect to a support (6), a coupling unit (3) which tenses a brake cable (4) when the handle is displaced (2), and a locking device (17) ensuring that the handle (2) remains in a locked position. The aim of the invention is to produce, a hand brake which is compact, cheap to produce, and which translates a traction force exerted onto the handle into a tensing of the brake cable. According to the invention, the handle (2) can be pulled away from the support (2) in an axial manner by means of a guiding device (5, 7), and the support (6) is coupled to a translation unit (8), which converts the axial displacement of a part associated with the handle (2) into a tensing of the brake cable (4).

The invention relates to a parking brake in accordance with the preamble of claim 1 for a vehicle, comprising a hand-grip which can be displaced relative to a holder, a coupling unit which tensions a brake cable during displacement of the hand-grip, and a locking device in order to hold the hand-grip in a locking position.

Parking brakes, in particular foot-operated parking brakes for motor vehicles, are known in practice which, when a brake actuation lever designed, for example, with a pedal is actuated, exert a corresponding pull on a brake cable pulling on the brake shoes of the parking brake, the latter being tensioned thereby. One disadvantage of these parking brakes is that the lever arm of the pedal, on the one hand, and the distance of the articulation of the brake cable from the articulation point, which is fixed on the bodywork, of the brake actuation lever, on the other hand, define unfavorable lever ratios (about 1 to 2), so that, in practice, tension members which bring about a step-up of about four times the pull exerted on them have to be installed between a first and a second part of the brake cable. Such tension members present problems, because, as a rule, the adjustment of the brake cable due to the wear of the brake linings is possible only on part of the brake cable and the adjustment can therefore be compensated for only inadequately. Moreover, these parts make it difficult to install the brake cable, because the latter can be led only at a distance from these and thus make the mounting more costly. In addition, a tension member of this type always forms a weak point for material faults and mounting errors.

The object of the invention is to provide a parking brake in accordance with the preamble of claim 1 which converts a tractive force applied to a hand-grip into a tensioning of the brake cable in a compact and cost-effective manner.

According to the invention, this object is achieved in the case of the parking brake mentioned at the beginning by the characterizing features of claim 1 in that the hand-grip can be pulled away axially from the holder via a guide, and in that a conversion unit is coupled to the holder and converts the axial displacement of a part assigned to the hand-grip into a tensioning of the brake cable.

The parking brake according to the invention requires little space in the region of the central console between the driver's seat and front-passenger seat and thus makes possible a plurality of novel options for utilizing the gain in space, for example for a cup-holder.

The parking brake according to the invention makes it possible to couple the brake cable to a pulling movement of the hand-grip without the driver having to overcome the load on the brake cable without any changes. On the contrary, the parking brake according to the invention converts the travel of the hand-grip, which can be pulled out, to the travel of the brake cable by it being possible to pull the hand-grip out of its guide by a number of centimeters. It is possible to assist the pulling force by means of a motor or by means of springs.

The design of the parking brake according to the invention makes it possible to design that part of a hand brake which is to be provided in the passenger compartment between the front seats to be very short by, for example, only the hand-grip being visible and the further region being used by arm rests or the like.

The parking brake according to the invention affords a favorable transmission ratio by the provision of a conversion unit which converts the axial movement of the hand-grip into another axial brake-cable tensioning movement.

The conversion unit is defined, for example by a gearwheel or friction wheel transmission which is used to actuate a lever on which the coupling unit is arranged. As an alternative, multi-joint kinematics may also be provided for the same purpose which comprises a lever, on which the coupling unit is articulated, and which can be pivoted relative to the holder about a pivot joint, with a force being applied to that limb of the lever which faces away from the coupling unit via a control link. Four links are preferably connected one behind another in this manner.

A locking catch is expediently prestressed by a catch spring in the direction of a tooth segment, with it being possible for the pretensioning of the catch spring to be canceled by actuation of a push-button or by pulling on a pull linkage, in order to release the locking position. The catch spring is formed, for example, as a leg spring, one leg of which is arranged on the lever holder and the other leg of which is arranged on the lever arm of the locking catch, which lever arm faces the toothing and has an engagement lug.

The parking brake according to the invention permits the achievement, in a compact manner, of a step-up of the brake actuation lever relative to the brake cable by a factor of two to eleven, preferably of four to ten. It has to be understood that, as before, brake-boosting members may be provided in the region of the brake cable, but this is advantageously no longer required. In particular, a step-up can be set which has an extent suitable for motor-vehicle parking brakes and manages without brake converters. The magnitude of the step-up results from the expedient selection of the distance of the joints of the lever from one another.

The coupling unit preferably comprises an adjusting device for the brake cable, as is disclosed, for example, in WO-A-98 57 832, said adjusting device being used, when the parking brake is set down or not actuated, to adjust the brake cable on the basis of a spring force in order, if there are large differences in temperature, but in particular due to the wear of the brake lining, to bring about a taut tensioning of the brake cable whenever the parking brake is released.

The parking brake according to the invention can be designed either as a hand-operated parking brake with a hand-grip, in which a push-button actuates the release function of the locking catch, or as a foot-operated parking brake, in which the brake actuation lever is provided with a pedal and the unlocking of the locking catch is realized via a pull mechanism.

Further advantages and features of the invention emerge from the following description and from the dependent claims.

The invention will be explained in more detail below using preferred exemplary embodiments of a parking brake according to the invention and with reference to the attached drawings.

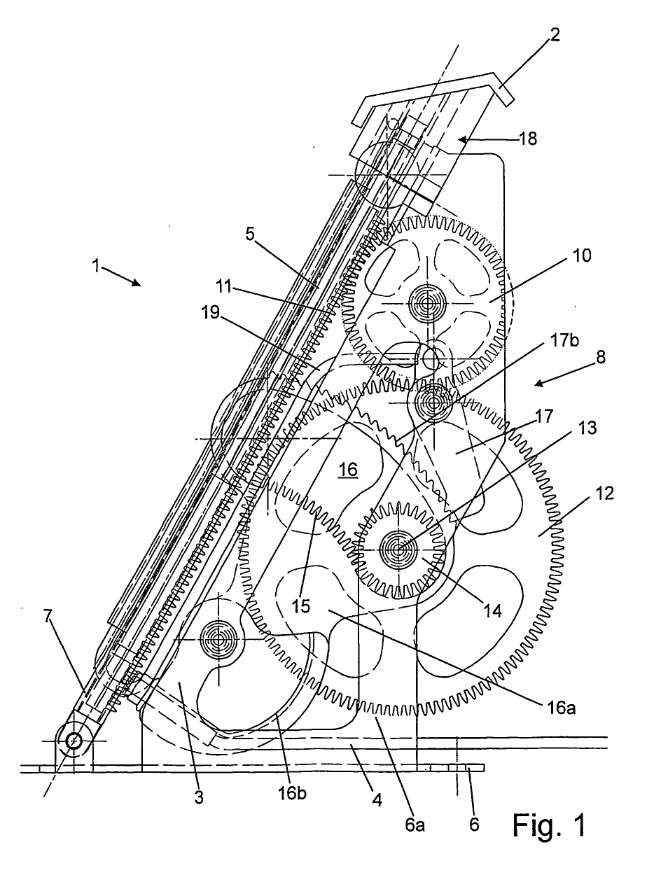

FIG. 1 shows a schematic side view of a preferred embodiment of a parking brake according to the invention in an unactuated state.

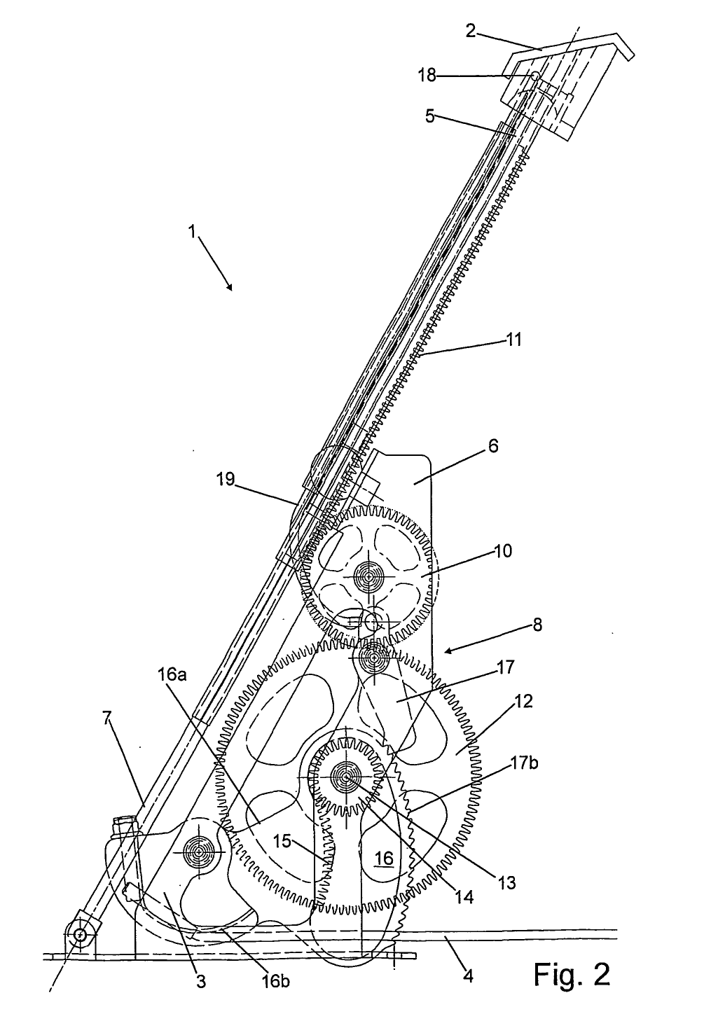

FIG. 2 shows a schematic side view of the parking brake according to FIG. 1 in an unactuated state.

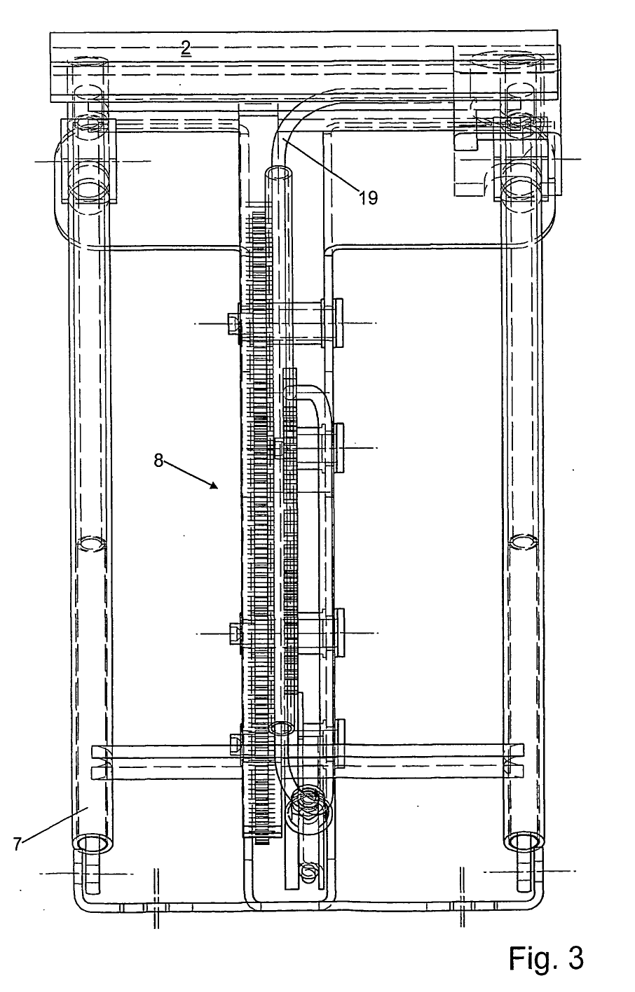

FIG. 3 shows a plan view from above of the parking brake according to FIG. 1.

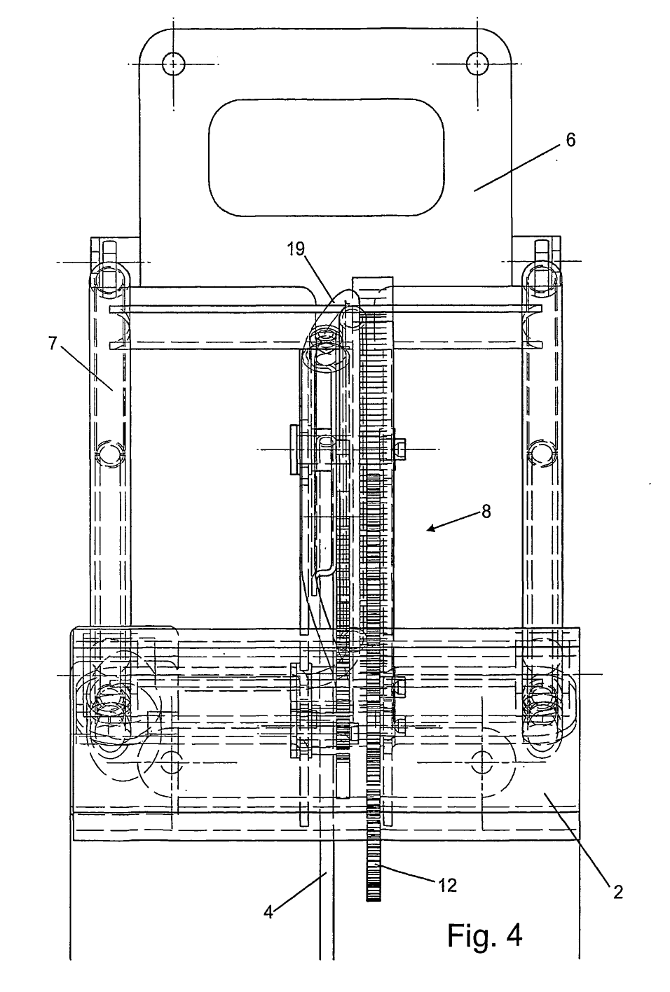

FIG. 4 shows a plan view from below of the parking brake according to FIG. 1.

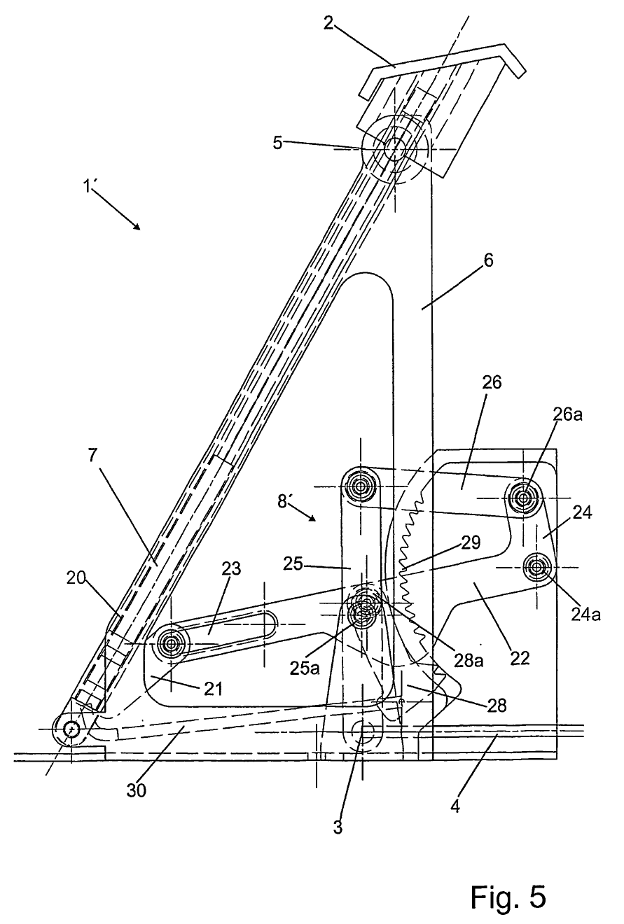

FIG. 5 shows a side view of a further preferred exemplary embodiment of a parking brake according to the invention in an unactuated state.

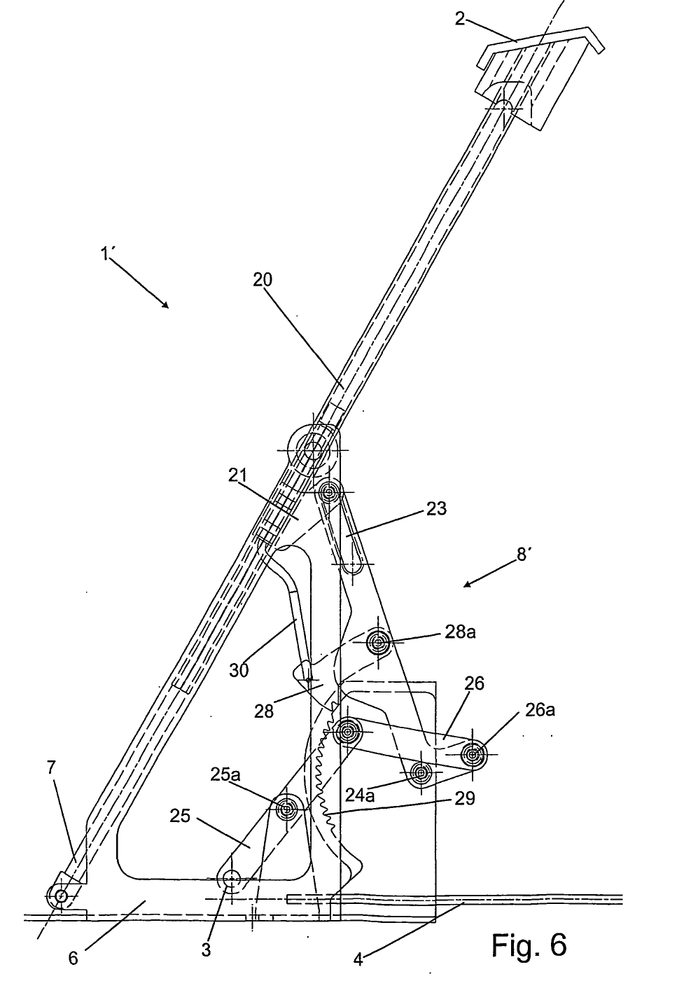

FIG. 6 shows a schematic side view of the parking brake according to FIG. 5 in an actuated state.

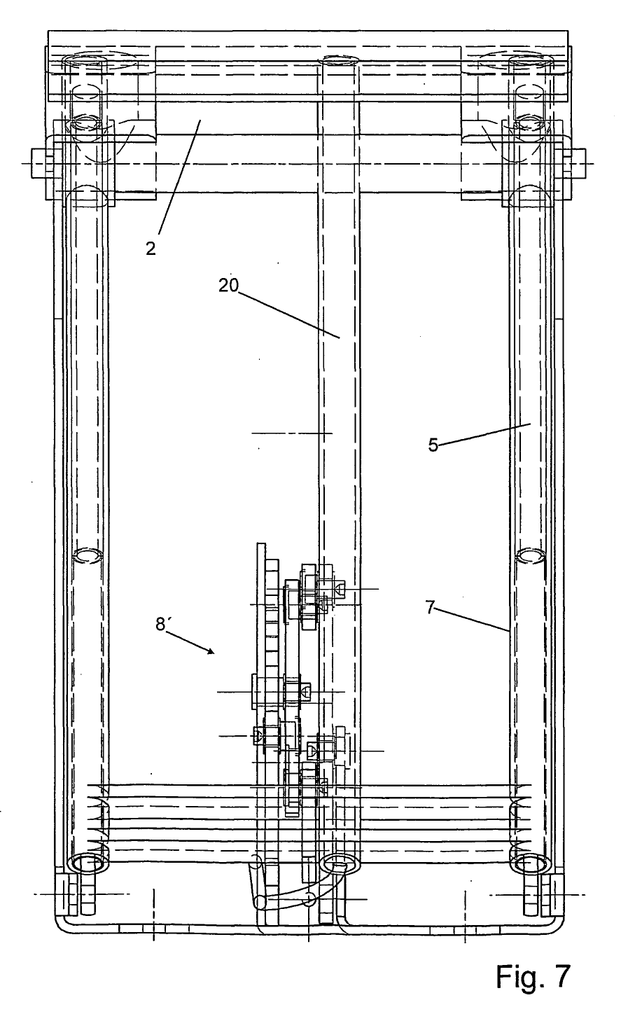

FIG. 7 shows a plan view from above of the parking brake according to FIG. 5.

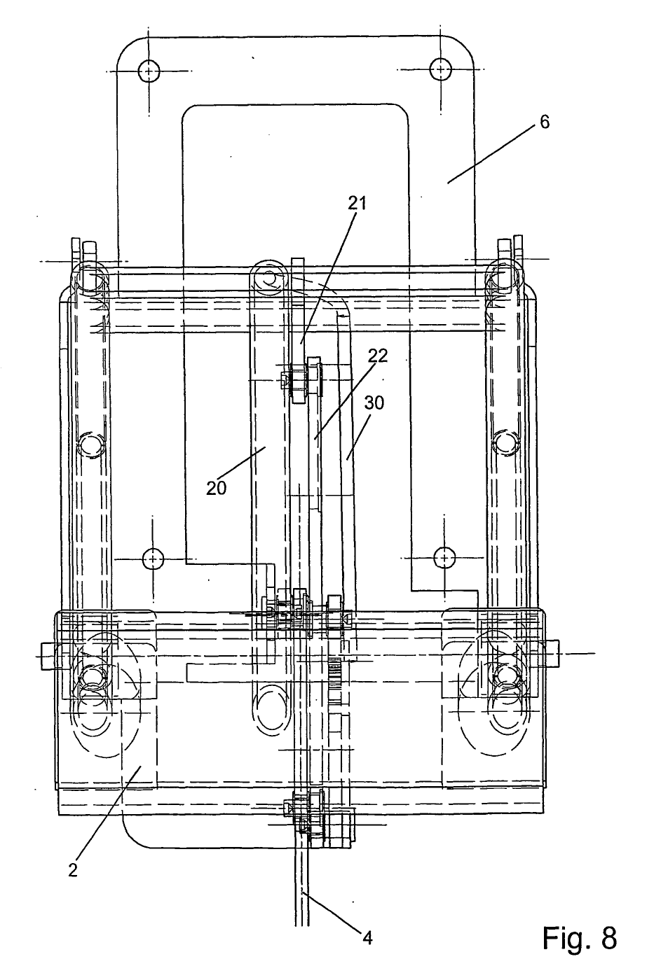

FIG. 8 shows a plan view from below of the parking brake according to FIG. 5.

The parking brake illustrated in FIGS. 1 to 4 is a hand-operated parking brake 1 which, by a hand-grip 2 being pulled, tensions a brake cable 4 fitted to a coupling unit 3. The hand-grip 2 is fastened on two parallel pins 5 which are arranged on the hand-grip 2 and, for the axial displacement in the direction of the pins 5, are guided axially in two tubes 7 which protrude parallel from a holder 6 fixed on a bodywork and which define a longitudinal guide. The upper end of the tube 7 is supported via a vertically protruding support 6a of the holder 6.

The tubes 7 protrude at an angle of approximately 30° with respect to the vertical and 60° with respect to the horizontal counter to the direction of travel of the vehicle, with the result that the hand-grip 2 can be ergonomically and favorably gripped and pulled by the driver's hand. For this purpose, cushioning for the ball of the thumb may be provided.

A conversion unit, which is denoted overall by 8, is connected between the hand-grip 2 and the coupling unit 3 for the brake cable 4 and converts the linear actuation of the hand-grip 2 into a likewise linear pulling movement on the brake cable 4, with, in the present case, in order to reduce the force required for the actuation, the longer travel of the hand-grip 2 bringing about a linearly and proportionally short travel of the brake cable 4 for tightening purposes.

For this purpose, the conversion unit 8 has a gearwheel transmission comprising a plurality of gearwheels. A first gearwheel 10 meshes with an extension 11 which protrudes from the hand-grip 2 in the displacement direction and is designed as a rack, the rack 11 performing the same travel in the pulling direction owing to its rigid connection to the hand-grip 2. The pulling direction leads past the first gearwheel 10 mounted on the protruding, vertical support 6a, as a result of which the first gearwheel 10 is driven when the hand-grip 2 is pulled. The gearwheel 10 is therefore mounted in a fixed position on part of the holder 6 and is used for transferring the linear movement of the rack 11 to a second gearwheel 12 which has approximately twice the diameter of the first gearwheel 10 and is mounted on a spindle 13, which is likewise arranged on the support 6a and on which a third gearwheel 14 is furthermore mounted, said gearwheel accordingly performing the same angular velocity and direction of rotation as the second gearwheel 12. The third gearwheel 14 has approximately one third of the diameter of the second gearwheel 12.

The third gearwheel 14 is supported in a lever 16a, in an elongated slot 16 which is provided with a toothed section 15 and has a curved profile, pulling of the hand-grip 2 and the movement transmitted via the transmission causing the third gearwheel 14 to roll along the toothed section 15 together with the spindle 13, and the lever 16a to pivot about an axis. A coupling unit 3, which is designed as a cable pulley 16b, for the brake cable 4 is likewise provided on the lever 16a in a pivotable manner, said coupling unit 3 being pivoted counter to the output direction of the cable 4 during mutual rolling of the third gearwheel 14 and of the toothed section 15. The force to be applied for pulling the hand-grip 2 then depends, firstly, on the transmission conversion and, secondly, on the lever ratios of the lever 16a, which lever ratios are defined by the center distances from the pivot axis.

A catch 17, which is arranged pivotably on the holder 6, is pretensioned by a spring in the direction of an outer toothing 17b, which is arranged on the lever 16a, and can then also engage in a ratchet-like manner with the periphery of the second gearwheel 12 when the spindle 13 is displaced. The lever 16a thus also defines a locking toothing 17b which essentially runs approximately parallel with the toothed section 15. The catch 17 can be released counter to the pretensioning of the spring and, if appropriate, a further securing spring, by actuation of a push-button 18 in the region of the hand-grip 2, which push-button is connected to the catch via a release device 19, whereby due to the tensile strength of the brake cable 3 acting on the conversion unit 8 the rack 11 and hence the hand-grip 2 are displaced back into a release position. It is possible to integrate a spring in the guide system of the hand-grip 2, enabling a spring also to be brought back over the last section in which the brake cable 4 is already relieved of load. The brake cable 4 preferably comprises an automatically adjusting control-cable adjustment which adjusts the brake cable in the unloaded state of the parking brake. The release device 19 is elastic and can therefore be pulled out.

A motor-driven power assist of the parking brake is preferably provided, either by hydraulic or pneumatic means in the region of the guide of the hand-grip or by a driven gearwheel, for example, together with the rack.

The further exemplary embodiment, illustrated in FIGS. 5 to 8, of a parking brake 1′ according to the invention has essentially the same components as the parking brake 1 described above, and so, for simplification purposes, the same reference numbers are used if the parts coincide in terms of function, and only the differences will be discussed in greater detail below.

In contrast to the parking brake 1, the parking brake 1′, illustrated in the FIGS. 5 to 8, has a conversion unit 8′ which is designed as a four-joint transmission. The four-joint transmission is actuated by an extension which is in the form of a link 20, is arranged rigidly or in an articulated manner on the hand-grip 2 and is connected pivotably and in an articulated manner via a coupling link 21 to a control link 22, the coupling link 21 engaging in an elongated slot 23 of the control link 22 and thus, during axial displacement of the link 20, compensating for the distance between the link 20 and control link 22 which initially becomes shorter and then is extended again.

The control link 22 is articulated pivotably via a joint 24a on a knee 24 in the region of the holder 6. An intermediate link 26 is arranged via a joint 26a on an end of the control link 22 that faces away from the knee and the elongated slot 23. The other end of the intermediate link 26 is connected in an articulated manner to a lever 25 which has the coupling unit 3 for the brake cable 4 at its other end and is articulated pivotably via a joint 25a on a protuding sheet-metal part of the holder 6.

The coupling device 3 accordingly transfers a pulling force to the brake cable 4 in accordance with the changing step-up which is defined by the center ratios of the links and lever.

A catch 28 is likewise arranged pivotably via a joint 28a on the control link 22 approximately in the center thereof and, by latching with a tooth segment 29 arranged on the frame 6, secures the locking position which is set in each case by pulling of the hand-grip 2. The catch 28 is pretensioned by a spring in the direction of the tooth segment 29 and can be released via a plunger rod 30 which is tensioned when a release button arranged in the region of the hand-grip 2 is actuated.

It is also possible here to provide a motor-driven auxiliary drive either in the region of the guide of the hand-grip 2 or in the region of one of the rotary joints of the four-joint transmission.

The two parking brakes 1 and 1′ advantageously enable the installation of a compact brake unit in the interior of a motor vehicle, so that the intermediate space in front of or behind the hand-grip 2 may optionally be provided for the arrangement of armrests, cup-holders or the like.

The invention has been explained above with reference to certain center distances of the joints or of the gear wheels. It has to be understood that the invention also makes it possible to arrange the center spacings in a different manner so as to set a certain step-up ratio, and it furthermore has to be understood that a further intermediate lever may also be provided in order to achieve a more favorable step-up. Finally, the elements which have been described from the two exemplary embodiments may also be combined in order to achieve a parking brake according to the invention.

The invention has been explained in greater detail above by way of example using a hand-operated parking brake 1 or 1′. It has to be understood that the parking brake according to the invention may also be designed as a foot-operated parking brake with a pedal, the hand-grip 2 then being provided as a pedal on which a pressure is exerted rather than a pull. The release button for releasing the locking catch may then also be provided at a different location than for the actuation by hand.

1. A parking brake for a vehicle, comprising
a hand-grip (2) which can be displaced relative to a holder (6),
a coupling unit (3) which tensions a brake cable (4) during displacement of the hand-grip (2), and
a locking device (17) in order to hold the hand-grip (2) in a locking position,
characterized in
that the hand-grip (2) can be pulled away axially from the holder (2) via a guide (5, 7), and
that a conversion unit (8; 8′) is coupled to the holder (2) and converts the axial displacement of a part assigned to the hand-grip (2) into tensioning of the brake cable (4).

2. The parking brake as claimed in claim 1, characterized in that the guide comprises at least one tube (7) in which a pin (5) arranged on the hand-grip (2) can be axially displaced in each case.

3. The parking brake as claimed in claim 2, characterized in that the at least one tube (7) has a slot in at least some sections, and an articulated section protruding through the slot is provided on the corresponding pin (5), the conversion unit (8; 8′) engaging on the articulated section.

4. The parking brake as claimed in claim 1 or 2, characterized in that an extension (11; 20) fitted on the hand-grip (2) parallel to the displacement direction is provided, said extension being connected rigidly to the hand-grip (2) and on which the conversion unit (8; 8′) engages.

5. The parking brake as claimed in one of claims 1 to 4, characterized in that the conversion unit (8) comprises a gearwheel transmission (10, 12, 14).

6. The parking brake as claimed in claims 4 and 5, characterized in that a first gearwheel (10) of the gearwheel transmission meshes with the extension of the hand-grip (2), which extension is designed as a rack (11).

7. The parking brake as claimed in claim 6, characterized in that a second gearwheel (12) having a larger diameter than the first gearwheel (10) meshes with the latter via its peripheral toothing.

8. The parking brake as claimed in claim 7, characterized in that a third gearwheel is provided coaxially with the second gearwheel (12) and can be displaced in an elongated slot (16), the elongated slot (16) having a toothed section (15).

9. The parking brake as claimed in claim 8, characterized in that the toothed elongated slot (16) has a curved profile.

10. The parking brake as claimed in claim 8 or 9, characterized in that the elongated slot (16) is arranged in a lever (16a) which can be rotated about an axis about which a cable pulley (16b) is also arranged.

11. The parking brake as claimed in one of claims 6 to 10, characterized in that the locking device comprises a catch (17) which engages in an outer toothing (17b) of the conversion unit (8).

12. The parking brake as claimed in one of claims 1 to 4, characterized in that the conversion unit (8′) comprises a multi-joint transmission.

13. The parking brake as claimed in claims 4 and 12, characterized in that the extension (20) is connected in the end facing away from the hand-grip (2) to a coupling link (21) which has an elongated slot (23) and on which at least two links of the multi-joint transmission are arranged.

14. The parking brake as claimed in claim 13, characterized in that two links of the multi-joint transmission act on a lever (25) which is articulated on the holder (6) and the other end of which are connected to the coupling unit (3) which tensions the brake cable (4).

15. The parking brake as claimed in claim 13 or 14, characterized in that a catch (17) is articulated on a control link (22).

16. The parking brake as claimed in one of claims 12 to 15, characterized in that the control link (22) has an elongated slot (23) in which a coupling link (21) is mounted.

17. The parking brake as claimed in one of claims 12 to 16, characterized in that the control link (22) is articulated on the holder (6) in the region of a knee and has, on a short limb, an intermediate link (26) which engages on the lever (25).

18. The parking brake as claimed in one of claims 1 to 17, characterized in that a catch spring for pretensioning a locking device, which is designed as a locking catch (17) in the direction of a tooth segment (15; 29) is provided.

19. The parking brake as claimed in one of claims 1 to 18, characterized in that a release device (18, 19) is provided in order to release the locking device (17).

20. The parking brake as claimed in one of claims 1 to 19, comprising a step-up of the hand-grip (2) relative to the brake cable (4) by a factor of to three to fifteen.

21. The parking brake as claimed in one of claims 1 to 20, characterized in that the coupling unit (3) comprises an adjusting device for the brake cable (4).

22. The parking brake as claimed in one of claims 1 to 21, which comprises a design of the hand-grip (2) for a hand-operated parking brake.

23. The parking brake as claimed in one of claims 1 to 21, which comprises a design of the hand-grip (2) as a pedal for a foot-operated parking brake.
